(19) United States
(12) Patent Application Publication
(10) Pub. No.: US 2016/0030270 A1
(43) Pub. Date: Feb. 4, 2016

(54) UPPER TORSO STRETCHING APPARATUS

(71) Applicant: c.h. Physical Therapy, LLC, Portland, OR (US)

(72) Inventors: Colin HOOBLER, Portland, OR (US); Robert SANDMEIER, Portland, OR (US)

(21) Appl. No.: 14/743,346

(22) Filed: Jun. 18, 2015

Related U.S. Application Data
(60) Provisional application No. 62/032,742, filed on Aug. 4, 2014.

(51) Int. Cl. A61H 1/02

(52) U.S. Cl. CPC A61H 1/0274; A61H 2201/1623; A61H 2201/1638

(57) ABSTRACT

Stretching of the pectoral muscles and other elements of the upper torso is optimized by pivoting arm guides arranged to be supported by the outstretched arms of a user reclining on an elevated support.

### CROSS-REFERENCE TO RELATED APPLICATIONS

This application claims the benefit of U.S. Provisional App. No. 62/032,742, filed Aug. 4, 2014.

### BACKGROUND OF THE INVENTION

The present invention relates to an apparatus for stretching the upper torso.

Sitting hunched over a computer screen causes chest muscles to tighten and, accordingly, weakening and loosening of postural muscles in the upper back resulting in excessive curvature (kyphosis) of the upper back (thoracic spine). Stretching the pectoralis minor and major muscles elongates the muscles and releases tension that can build up within the muscle fibers, decreasing tightness in the upper chest and improving posture and breathing.

Another problem related to the muscles and connective tissue of the upper torso is adhesive capsulitis or frozen shoulder. Adhesive capsulitis is a disorder in which the shoulder capsule, the connective tissue surrounding the glenohumeral joint of the shoulder, becomes inflamed and stiff, greatly restricting motion and causing chronic pain. The restricted movement and chronic pain can make even small tasks impossible and certain movements or contact can cause extreme pain or cramping which can last several minutes. Treatment may include physical therapy, massage or surgery to break up the adhesions and scar tissue in the joint. Physical therapy commonly incorporates stretching of the muscles, tendons and ligaments comprising the joint.

Upper torso stretching is also a common component in the treatment of cervical disc disease and degenerative arthritis of the spine.

The pectoral muscles and other elements of the upper torso can be stretched by abducting the arms while lying on the floor but the floor maintains the arms at a constant angle to the body reducing the force applied to the muscles as the muscles stretch which is not as effective as a stretch in which a constant torque is applied to the shoulder joint throughout the stretching activity. What is desired, therefore, is an apparatus enabling application of constant torque during stretching of the upper torso.

### BRIEF DESCRIPTION OF THE DRAWINGS

FIG. 1 is a perspective drawing of an exemplary upper torso stretching apparatus.

FIG. 2 is a plan view of the upper torso stretching apparatus of FIG. 1.

FIG. 3 is a section view of the upper torso stretching apparatus of FIG. 1 taken along line 3-3 of FIG. 1.

FIG. 4 is a partial section view of the upper torso stretching apparatus of FIG. 1 taken along line 4-4 of FIG. 3.

### DETAILED DESCRIPTION OF PREFERRED EMBODIMENTS

Treatment of various conditions affecting the upper torso, including poor posture and adhesive capsulitis, commonly involves stretching the pectoral muscles and other elements of the shoulder joint and upper torso. Abductive upper torso stretching activities are often performed on a floor which maintains the arm at a constant angle to the shoulder joint resulting in a reduction of the force applied to the muscle as the muscle elongates. The inventor appreciated that the benefit of upper torso stretching is optimized by maintaining a constant torque on the joint during stretching so that the pectoral muscles and other upper torso elements will continue to experience substantially same force even as the muscle elongates due to the stretching. The inventor concluded that a constant torque (or substantially constant) and/or constant load (or substantially constant) could be applied to the shoulder joint by gravity acting on a user's outstretched arms if the user was supported sufficiently far above the floor so that the arms could abduct past the back of the body without making contact with the floor.

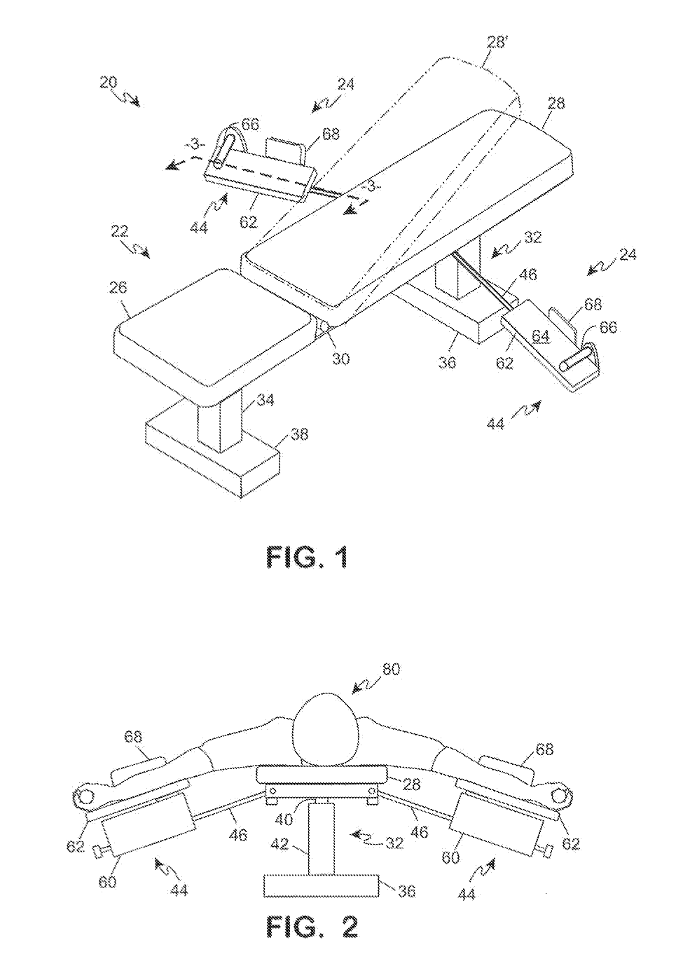

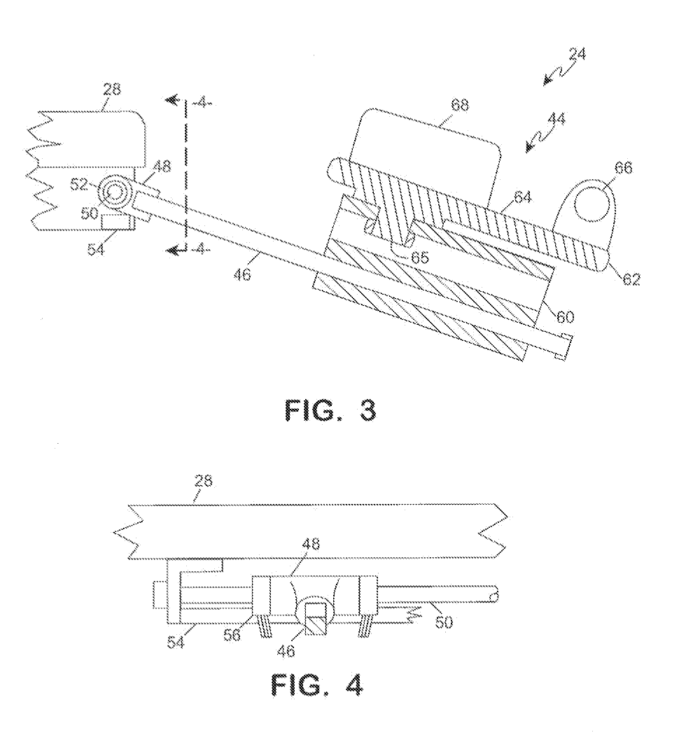

Referring in detail to the drawings where similar parts are identified by like reference numerals, and, more particularly to FIGS. 1-4, the exemplary upper torso stretching apparatus 20 comprises generally an elongate, elevated bench 22 to support the user's back and arm guides 24 pivotally connected to and projecting substantially normal to the longitudinal axis of the bench from each side of the bench. The bench 22 preferably comprises a seat portion 26 and a backrest portion 28. The seat portion and the backrest portion are preferably connected by a hinge 30 permitting the backrest portion to be inclined 28′ relative to the plane of the seat portion. Typically the bench is supported by first 32 and second 34 support columns attached to respective floor engaging members 36, 38. The first support column 32 attached to the backrest 28 may comprise telescopic external 42 and internal 40 support portions respectively attached to the floor engaging member 36 and slidably and/or hinged attached to the backrest 28 to enabling inclination of the backrest relative to the seat portion 26.

The arm guides 24 comprise, generally, a forearm guide 44 preferably slidably attached to a support beam 46 which may project substantially normal to the longitudinal axis of the bench and which is pivotally and, preferably, slidably attached to the backrest portion 28. One end of the support beam 46 may be affixed to a stem portion of a tee-shaped fitting 48 which is pivotally and, preferably, slidably attached to a support rod 50 by a bushing 52 which encircles the support rod and is retained in the run portion of the tee fitting 48. Preferably, the support rod 50 is arranged substantially parallel to a longitudinal axis of the elongate bench and the tee fitting 48 is selectively slidable along the support rod to enable adjustment of the position of the arm guides 24 so that the forearms of users of differing stature may engage the forearm guides 44 when the arms are extended substantially normal to the spine or when the user's arms and torso form a Y with the hands “above” the shoulders. Alternatively, and or in addition to, the support rod 50 may be arranged in a “Y” arrangement to a longitudinal axis of the elongate bench and the tee fitting is selectively slidable along the support rod to enable adjustment of the position of the arm guides so that the forearms of users of differing stature may engage the forearms guides when the arms are extended in a substantially “Y” arrangement to the spine or when the user's arms and torso form a Y with the hands “above” the shoulders. The longitudinal location of the tee fitting 48 on the support rod 50 is preferably selectively securable, for example by pins engageable with apertures spaced along the support rod or collars 56 comprising selectively engageable disc clutches. While the arm guides 24 preferably freely pivot on the support rod 50, a stop 54 may be affixed to the backrest portion and arranged to contact the support rod or the tee fitting to prevent the arm guides striking the floor when released.

The forearm guides 44 comprise a body 60 which preferably slidably engages the support beam 46 but, preferably, is arranged to resist rotation about the longitudinal axis of the support beam. To resist rotation of the body about the support beam, the support beam 46 may comprise a beam or tube with a square, hexagonal or other quadrilateral cross-section which is engaged by correspondingly arranged bearing surfaces of the body 60. A forearm support 62, including a forearm support surface 64 provides support along the length of the user's forearm. Preferably, the forearm support 62 is attached to the body 60 by a pivot 65 located in a position corresponding approximately to the location of the user's elbow to enable the forearm support to align with the longitudinal axis of user's forearm when the forearm's axis is not parallel to the axis of the support beam 46. A hand grip 66 is affixed to the forearm support 62 near its end distal of the bench 22. The forearm support 44 may also comprise a forearm guide 68 arranged substantially normal to the forearm support surface 64 to aid the user in maintaining contact with the forearm support.

As illustrated in FIG. 2, to stretch the upper torso, the user 80 reclines on the bench 24 and extends the arms outward, typically, either normal to the body or at an angle to the body with hands “above” the shoulders so that the body and the arms form a Y, and grips the hand grips 66. The torque at the shoulder joint, produced by gravity acting on the outstretched arms and the arm guides 24, is resisted by the counter torque generated by the pectoral muscles and other elements of the upper torso. As the muscles stretch, the elevated arm guides 24 can move downward maintaining a substantially constant torque at the shoulder joint even as the forearms abduct behind the user's back. If stretching while reclining on the apparatus is too vigorous for a particular user, the bench can be inclined upward to reduce the component of the gravitational force pulling the arms back. Alternatively, or in addition to, the device may be configured so that as the muscles stretch, the elevated arm guides can move downward maintaining a substantially constant load at the shoulder joint even as the forearms abduct behind the user's back.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. An upper torso stretching apparatus comprising:
(a) an elongate elevated support for said torso; and
(b) an arm guide pivotally attached to said elevated support and arranged to project at an angle to a longitudinal axis of said elevated support, said arm guide including a hand grip proximate an end portion of said arm guide distal of said elevated support.

2. The upper torso stretching apparatus of claim 1 wherein said arm guide is arranged to project substantially normal to said longitudinal axis of said elevated support.

3. The upper torso stretching apparatus of claim 1 wherein said arm guide comprises:
(a) a support beam pivotally attached to said elevated support;
(b) a forearm guide body slidably attached to said support beam; and
(c) a forearm support attached to said forearm guide body and including a forearm support surface, said hand grip attached to said forearm support.

4. The upper torso stretching apparatus of claim 3 wherein said forearm support is pivotally attached to said forearm guide body.

5. The upper torso stretching apparatus of claim 4 wherein said pivotal attachment of said forearm supporting and said forearm guide body is approximately coincident with an elbow of an arm when a hand of said arm is engaging said hand grip.

6. The upper torso stretching apparatus of claim 1 wherein the elongate elevated support comprises:
(a) a seat portion; and
(b) a backrest portion hingedly attached to and inclinable relative to said seat portion, said arm guide attached to said backrest portion.

7. The upper torso stretching apparatus of claim 1 wherein said arm guide is selectively slidable relative to and substantially parallel to said longitudinal axis of said elevated support.

8. An upper torso stretching apparatus comprising:
(a) an elevated support for an upper back of a user's torso;
(b) an elongate support beam pivot affixed to said support and arranged substantially parallel to a side of said support;
(c) a support beam pivotally attached to and selectively slidable on said support beam pivot;
(d) a forearm support slidable on said support beam and pivotal on a forearm support pivot about an axis substantially normal to a longitudinal axis of said support beam; and
(e) a hand grip affixed to said forearm support distal of said forearm pivot.

9. The upper torso stretching apparatus of claim 8 further comprising a forearm guide extending generally normal to a forearm supporting surface of said forearm support between said hand grip and said forearm pivot.

10. A method of stretching a muscle of a user's upper torso, the method comprising the steps of:
(a) supporting an upper back of said user above a floor; and
(b) supporting with an outstretched arm, an elevated arm guide arranged to pivot about an axis substantially parallel to a longitudinal axis of said torso.

11. The upper torso stretching apparatus of claim 1 wherein said arm guide provides a substantially constant load with an arm supported thereon.
